(19) United States
(12) Patent Application Publication
(10) Pub. No.: US 2006/0004546 A1
(43) Pub. Date: Jan. 5, 2006

(54) Sensor device for a physical quantity in a device

(76) Inventor: Konrad Slanec, St. Julians (MT)

Correspondence Address: JACOBSON HOLMAN PLLC, 400 SEVENTH STREET N.W., SUITE 600, WASHINGTON, DC, 20004, US

(21) Appl. No.: 11/173,003

(22) Filed: Jul. 5, 2005

(30) Foreign Application Priority Data
Jul. 2, 2004 (DE) 10 2004 032 075.6

(51) Int. Cl. G06F 15/00

(52) U.S. Cl. 702/189

(57) ABSTRACT

The sensor values (s) of a sensor device (6) exhibit, in the delivered condition, sensor values in a delivered scale that are reduced by about 50%, which document at the same the condition at the time of delivery. After the installation in a device, an initialization and justification process of the sensor device is started on crossing of the threshold values (t), in course of which the delivered scale (ds) is converted into a normal operating scale (os).

The invention relates to a sensor device for the measurement of a physical quantity in a device and a method for justification of the sensor device, whereby an emitted sensor signal for the adjustment to the actual measurement range of the quantity can be scaled by means of an evaluation electronic unit.

In automobiles it is common, for instance, to couple an actuating control element, built as a foot pedal with a sensor, which detects the angular position of the pedal. The adjustment of a positioning signal of the foot pedal takes place according to the build in the automobile, in that in a catch position of the foot pedal, an auxiliary signal is set through an external signal input or the position of the sensor itself is adjusted mechanically. The signal level in the sensor at that moment is then stored as the initial value and is later subtracted or compensated during the subsequent operation. In a correction of that type, it is not possible with certainty afterwards to determine, based on the sensor values, whether the sensor had undergone the final adjustment or not.

The underlying problem of the invention was to increase the accuracy in the process of the justification.

This problem is solved through the characteristics given in the preamble of claim 1. The readjustment of the sensor signal takes place through the sensor electronics itself, after all the necessary steps for the justification is carried out. With that, a control device is in a positing to always determine reliably, whether a justification was carried out completely or not. For example, the central steering system, present in an automobile can thwart the starting off, if the initial value is set too high.

Further advantageous enhancements of the invention follow from the characterizing features of claims 2 to 10.

The variation in the carrier frequency according to claim 2 represents a simple and reliable means for determining the status of the sensor. The frequency of the sensor in the delivered condition can be set in such a fashion that an emitted signal cannot be processed by the central control system.

In case of the sensor according to claim 3, the lower threshold of the deformed scale in delivered condition can lie, for example, distinctly above the maximum lower threshold value to be set up. The adjusted normal operational scale of, for instance, a pulse wide modulated sensor signal, is usually set to a value of 10%-90%. The scale in delivered state beginning, for example, at the value 25%, is clearly above the tolerance limit.

With the further enhancement according to claim 4, it is possible to determine the uppermost and lowermost measurement values of the in-built sensor, for example by means of linearized delivery scale, and to shift those measurement values to the threshold value of 10% to 90%, without changing thereby the characteristic of the delivery scale, so that no further intermediate values need to be adjusted. Additional comparative measurements by means of additional interceptive measuring devices become therefore superfluous.

In the further enhancement according to claim 5, the operating scale can be extended approximately proportionally in a simple manner.

The sensor device according to claim 6 is suitable especially for the determination of a operating element, for example, for determination of the angle of a pedal with fixed final mechanical stops.

The control device according to claim 7 is, for example, a part of the sensor electronics, which also monitors the complete justification process in autonomous manner. Linking with other testing devices is not necessary.

The method according to claims 8 and 9 enables a simple and secure justification of sensing devices. For example, after the switching on of the power supply, a first pedal actuation beyond the preset upper threshold values, the signal output monitors the dwelling of the actuating element in a hold position. If this value is reached and held at least once again, it is assigned to an upper stop position and the delivery scale is transformed to the operational scale, so that the data technical initialization of the actuating element is completed.

In a further enhancement according to claim 10, the warning signal can be triggered in a simple manner, for example, through warning device that is meant anyway for that purpose.

An exemplary embodiment of the invention is shown in the drawing and is explained further in the following. Shown are:

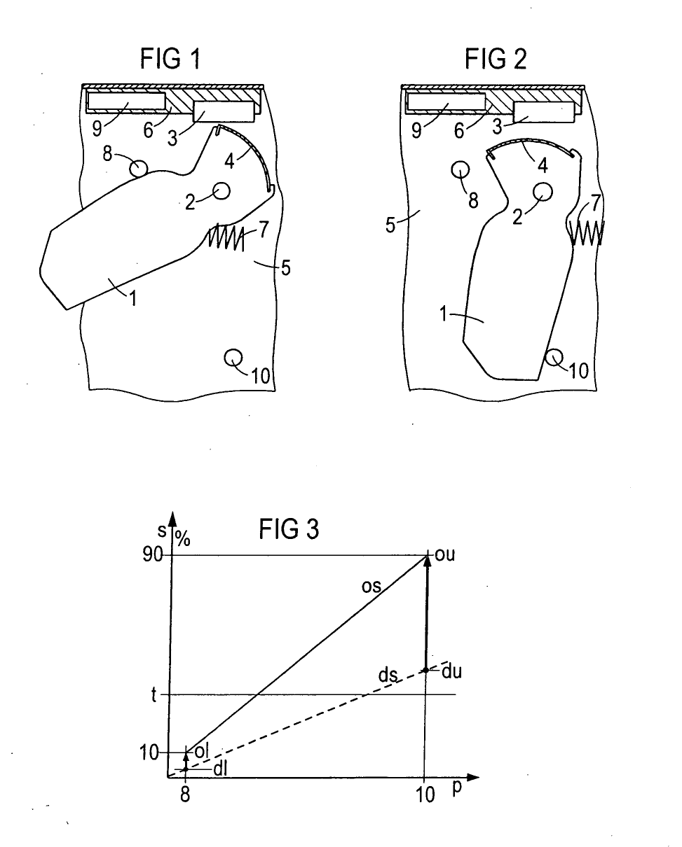

FIG. 1 A schematic partial side view of a pedal device of an automobile with a displacement transducer in an initial position,

FIG. 2 The parts according to FIG. 1 in a functional position

FIG. 3 Curve diagrams of the sensor values against the changing position of the pedal of the pedal device according to FIG. 1.

According to FIG. 1, a mechanically adjustable component in the form of a foot pedal 1, serving as an operating organ, is supported swivelably about a pedal axis 2 in a housing 5, which can be set up in the legroom of an automobile. Above the foot pedal 1 is a stationary coil part 3, which induces an electromagnetic alternating field oriented to the foot pedal 1. The coil part 3 is a part of a sensor device 6 fastened to the housing, which is attached to the housing 5 and contains an evaluation electronic element 9 for the coil part.

At the foot pedal 1, a metal part 4 is set up, which forms, together with the coil part, an inductive sensor, and whose distance from the coil part varies in dependence of the swing position of the foot pedal 1. That actuates the corresponding change in the inductive resistance of the coil part 3, which leads to the corresponding change in the measurable power loss of the coil part 3. The metal part 4 raised from the sheet exhibits a convex cam like curvature, the course of which is such that the output signal of the sensor change approximately proportional to the angular position of the foot pedal 1.

In the initial position shown, the foot pedal rests against the force of the retractive elastic force 7, at the catch at rest 7 of the housing 5, and assumes thereby the rest position, the sensor value of which represents the corresponding initial value. An end of the metal part 4 is closely adjacent to the coil part 3 and influences its electromagnetic alternating field accordingly.

According to FIG. 2, the foot pedal is swiveled to a functioning position at an end stop position 10, in which the distance to the coil part 3 is significantly increased. The inductive resistance of the coil part, and therewith the sensor value, sent out by the evaluation electronics have changed accordingly.

FIG. 3 shows the curve of the sensor values s of the sensor signal before and after the initialization of the pedal, in dependence of its position p between the rest position 8 and the end stop 10, whereby a linear delivery scale ds maps the sensor values preset by the manufacturer of the sensor device, and the operating scale os maps the converted sensor values. The maximum values of the not yet initialized sensor device in the delivery scale lie at 50% of the operating scale.

After the assembly of the sensor in the pedal mechanism and switching on of the power supply, the pedal is pressed through from the rest position 8, corresponding to sensor value dl, to the end stop with the sensor value du, whereby with the crossing of the threshold value t, which lies clearly below the sensor value du, a justification program of the regulation and evaluation electronics is started, and the dwelling of the sensor values du and the subsequent dl are respectively associated to the end stop position or the rest position. These values must then be confirmed at least by a further operating cycle reaching these stops. Whereupon, the evaluation electronics converts the delivered scale into the operating scale, with approximately doubled sensor values, whereby the sensor value dl of the rest position 8 is shifted to ol and the sensor value ol of the end position stop 10 is shifted to ou and the linear relationship with to the pedal position remains preserved. If the preset operating cycles are not completely, the delivery scale remains unchanged, which can be detected with certainty in the later operating phases and can trigger the corresponding warning signal.

### LIST OF REFERENCE SYMBOLS

1 Foot pedal
2 Pedal axis
3 Coil part
4 Metal part
5 Housing
6 Sensor device
7 Retracting spring
8 Rest position
9 Evaluation electronics
10 End stop
11 s Sensor value
t Threshold value
p Position
os Operating scale
ds Delivered scale

1. Sensor device (3) for measuring a physical quantity in a device, whereby an emitted sensor signal for the adjustment to the actual measuring range of the quantity can be scaled by means of an evaluation electronic element (9), characterized in that before the assembly into the device the sensor signal exhibits characteristics which differ significantly from the normal sensor signal of ready-to-operate sensor device, and that the sensor signal of the installed sensor can set in the first scaling of the sensor to the normal characteristics.

2. Sensor device according to claim 1, characterized in that the sensor signal exhibits a carrier frequency, which can be converted into a defined operating frequency that deviates markedly from the preset frequency in the delivered state.

3. Sensor device according to claim 1, characterized in that the sensor device (6) exhibits a delivered scale (ds) with a threshold value (du) of the sensor signal before the installation into the device, which value lies distinctly outside the corresponding threshold range (ou) of the final scaled ready-to-operate sensor device (6).

4. Sensor device according to claim 3, characterized in that the delivery scale (ds) reproduces the value of the physical quantity according to a defined curve.

5. Sensor device according to claim 3, characterized in that the maximum value (du) of the sensor signal of the delivered scale (ds) is distinctly below the maximum value (ou) of the sensor signal of the scaled sensor device (6) ready-to-operate.

6. Sensor device according to claim 3, characterized in that the sensor device (6) detects the position of a mechanical actuating element, whose adjustment range is limited by the stops.

7. Sensor device according to claim 1, characterized in that the evaluation electronics (9) comprises a control device for the initialization and control of the justification.

8. Method for justification of the scalable sensor device (6) according to claim 1, characterized in that the dwelling of the sensor value outside a preset threshold value (t) of the delivered scale (ds) is evaluated as the end position of the actuating element in the final assembly.

9. Method according to claim 8, characterized in that the operating scale (os) or the defined operating frequency of the sensor device (6) is adjusted only after a repeated detection of the end position.

10. Method according to claim 8, characterized in that in case of a unsuccessful initialization, the control device generates a control signal for triggering a warning signal to an internal or an external signaling element.
